(19) United States
(12) Patent Application Publication
(10) Pub. No.: US 2017/0225579 A1
(43) Pub. Date: Aug. 10, 2017

(54) Self Charging All Electric Vehicle

(71) Applicants: Angelo E. Mascia, Scarsdale, NY (US); Joseph A. Mascia, Yonkers, NY (US)

(72) Inventors: Angelo E. Mascia, Scarsdale, NY (US); Joseph A. Mascia, Yonkers, NY (US)

(21) Appl. No.: 15/018,364

(22) Filed: Feb. 8, 2016

(51) Int. Cl. B60L 11/18; H02J 7/00

(52) U.S. Cl. CPC B60L 11/1822; B60L 11/1853; B60L 11/1864; H02J 7/0054; B60L 2270/12; B60L 2270/142

(57) ABSTRACT

A self-charging all electric vehicle comprising three or four banks of batteries, FIG. 1 and FIG. 1A, to power in rotation, one or two at a time, the prime mover 12, a permanent magnet direct current motor. A three-wire direct current generator 13 which provides two 125 voltages to charge simultaneously two banks of batteries 10 and 250 volts to power the traction motors FIG. 4 and FIG. 5 for producing rotational energy. The generator is driven by the drive shaft of the prime mover.

### CROSS-REFERENCE TO RELATED APPLICATIONS Not Applicable

### FEDERALLY SPONSORED RESEARCH Not Applicable

### SEQUENCE LISTING Not Applicable

### (1) BACKGROUND OF THE INVENTION

All plug-in electric hybrid and battery electric vehicles can drive only a short distance on electric power alone. How far the cars will go on a charge, how long the recharging process will take, and even how drivers will be billed for electricity when they recharge away from home, are matters to sort out. Making the electricity available to recharge batteries is just one of the hurdles carmakers must address. Normal battery-pack charging using home current takes long hours. High voltage circuits battery chargers are very expensive.

The ranges of a plug-in hybrid are mostly predicated on low speed and intermittent city driving. The weight of the gas engine in a plug-in car cuts into the distance the car can drive in battery-only mode. Selecting the all-electric mode in a plug-in hybrid limits the top speed and acceleration.

The big problem with electric cars is called “range anxiety”: the fear that you run out of power before you reach your destination. In some electric cars, after the batteries die, a gasoline engine under the hood turns on, powering a turbine that generates more electricity to drive the car. Companies have found it hard to deliver affordable and practical fully electric vehicles to the mass market.

Proposals being considered to alleviate the problems with electric cars seem expensive, challenging, and in need of long periods of time to accomplish. The creation of battery swapping stations to be used for longer drives would be expensive for the drivers. Fitting cars with battery packs large enough to give a reasonable driving range remains a big packaging challenge.

The installation of public charging stations for electric vehicles along major highways would take years to accomplish. There are very few publicly accessible places to recharge hybrid cars.

### (2) SUMMARY OF THE INVENTION

A self-charging all electric vehicle comprises 3 or 4 banks of batteries to power in turn, one or two at a time, the prime mover, a three-wire direct current generator, and 1 or 2 traction motors for producing rotational energy.

### Advantages

Accordingly several advantages of one or more aspects are as follows:

No fossil-fuel fill-ups.
No tailpipe emissions at all.
Eliminates pollution in the environment from automobiles.
Environmental quality will be enhanced.
No engine, no oil to change.
No need for oil, fire, smoke, noise, clutch or gear box.
No installation of public charging stations needed along major highways.
Makes a contribution in terms of energy and climate.
No power needed from a standard household outlet.
No expensive high-voltage circuits battery chargers needed.
No range anxiety problem.
No battery-swapping stations necessary for longer drives.
Maintenance is absolutely minimal.
There is no radiator to clean and fill, no transmission to foul up, no fuel pump, no carburation problems, no muffler to rot out or replace, and no pollutants emitted in the atmosphere.

### (3) DESCRIPTION OF THE DRAWINGS

FIG. 1 shows three banks of batteries to power the prime mover motor, one at a time.

FIG. 1A shows four banks of batteries to power the prime mover motor, two at a time connected in series.

FIG. 2 shows the floating charge method of charging 3 banks of batteries.

FIG. 2A shows the floating charge method of charging 4 banks of batteries.

FIG. 3 shows the constant potential method of charging 3 banks of batteries.

FIG. 3A shows the constant potential method of charging 4 banks of batteries.

FIG. 4 and FIG. 4A show the front wheels-drive-version whereby the vehicle will be self-propelled to roll along a surface.

FIG. 5 and FIG. 5A show the four-wheels-drive-version whereby the vehicle will be self-propelled to roll along a surface.

### DRAWINGS—REFERENCE NUMERALS

10 banks of batteries
11 microcontrollers or automatic transfer switches
12 prime mover, a permanent magnet direct current motor
13 250 volts three-wire direct current generator
14 connections of the internal collector rings and balance coils of the three-wire direct current generator
15 small series resistor for the constant potential method of charging
16 front electric motor
17 front wheels
18 rear electric motor
19 rear wheels
20 speed controller of the prime mover
21 speed controller of the front electric motor
22 speed controllers of the front and rear electric motors

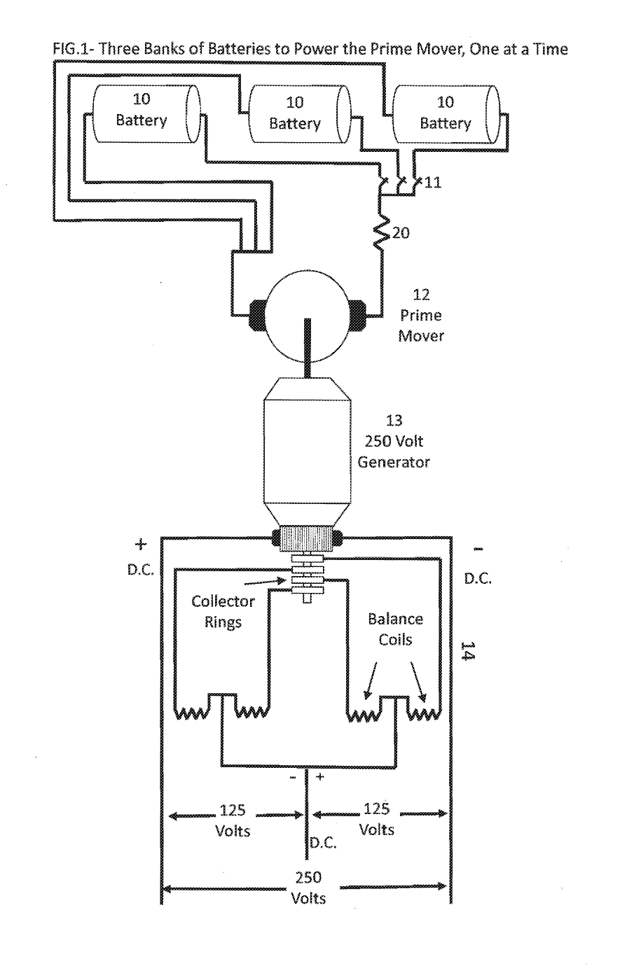

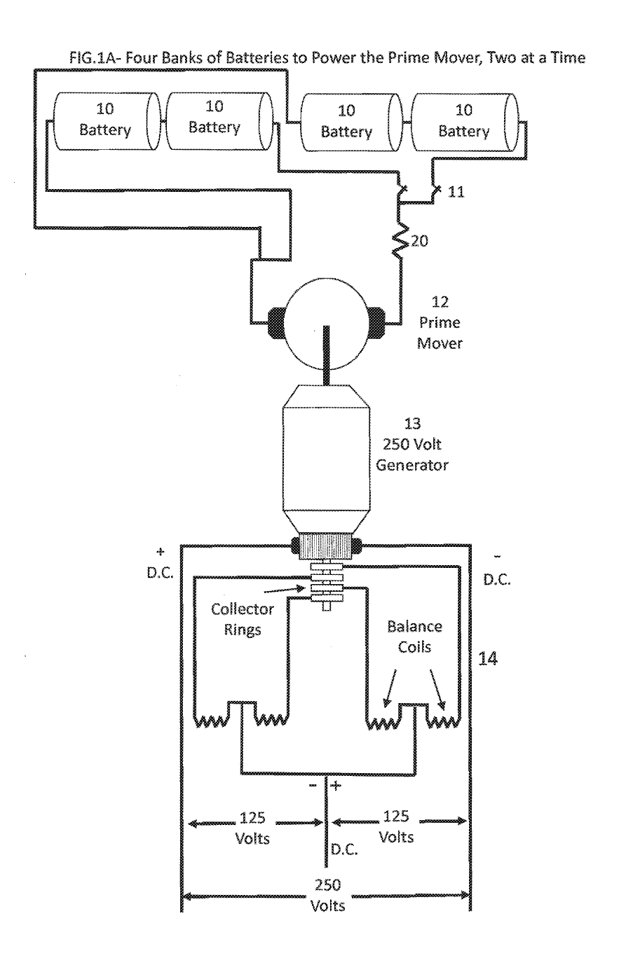

FIG. 1 shows three banks of batteries 10 to power the prime mover motor 12 one at a time, through the microcontrollers or automatic transfer switches 11 and the speed controller 20. The prime mover 12 supplies the turning force necessary to turn the shaft of the three-wire direct current generator 13 to provide 125 volts from either side of the neutral wire and 250 volts to power the traction motor or motors.

FIG. 1A shows four banks of batteries 10 to power the prime mover motor 12, two at a time connected in series, through the microcontrollers or automatic transfer switches 11 and the speed controller 20. The prime mover 12 supplies the turning force necessary to turn the shaft of the three-wire direct current generator 13 to provide 125 volts from either side of the neutral wire and 250 volts to power the traction motor or motors.

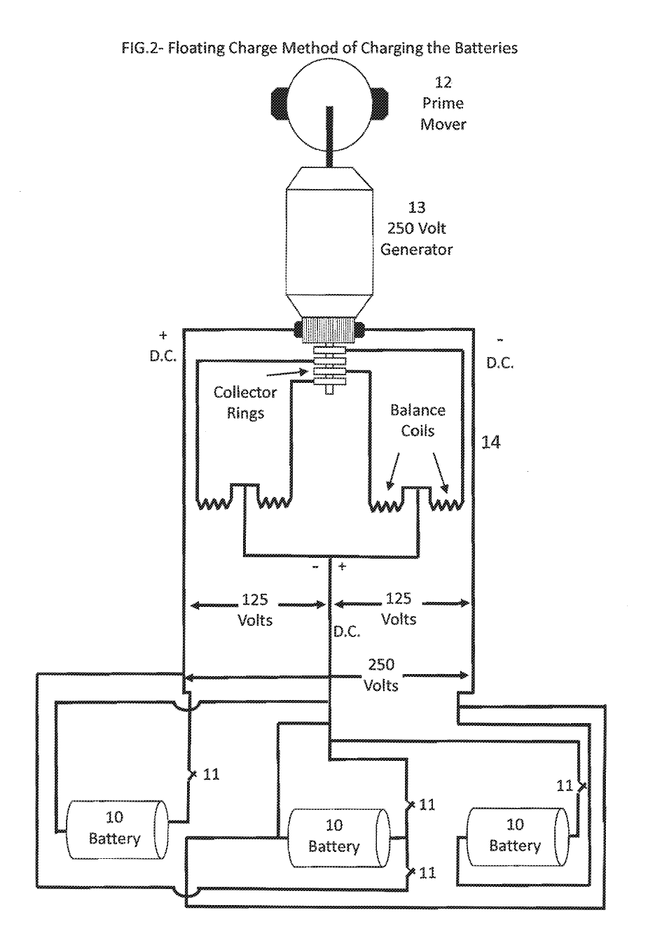

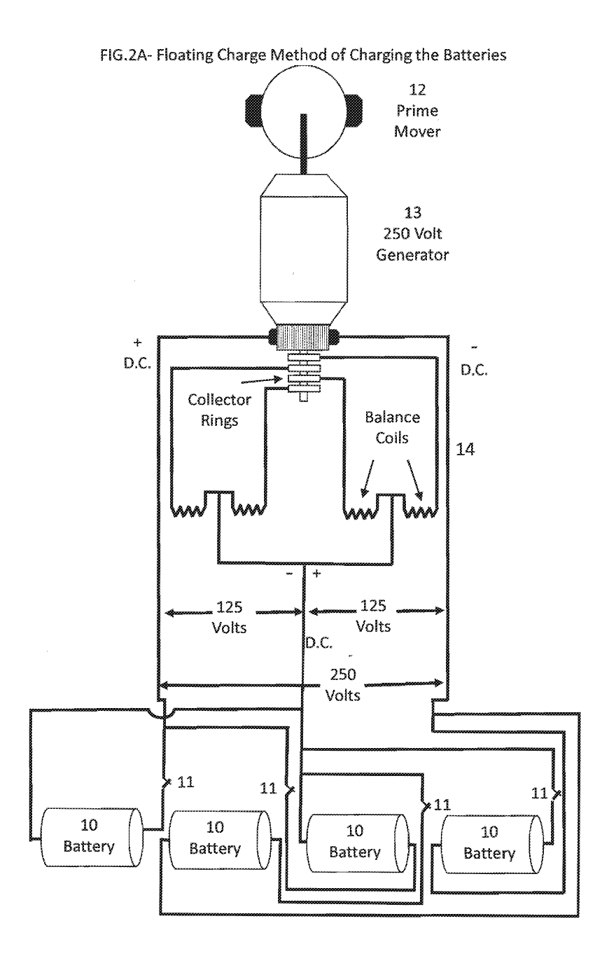

FIG. 2 can have three banks of batteries 10 containing 58 lead acid cells each being charged by the floating charge method two at a time. The three-wire dc generator 13 provides 125 volts from either side of the neutral wire to maintain a charging voltage within the limits of from 2.13 to 2.17 volts per cell of the battery with an average as close to 2.15 volts as possible.

FIG. 2 can also have three banks of batteries 10 containing 35 lithium-iron phosphate cells each being charged by the floating charge two at a time. The three-wire dc generator 13 provides 125 volts from either side of the neutral wire to maintain a charging voltage of a little over 3.57 volts per cell.

FIG. 2A can have four banks of batteries 10 containing 58 lead acid cells each being charged by the floating charge method two at a time. The three-wire dc generator 13 provides 125 volts from either side of the neutral wire to maintain a charging voltage within the limits of from 213 to 2.17 volts per cell of the battery with an average as close to 2.15 volts as possible.

FIG. 2A can also have four banks of batteries containing 35 lithium-iron phosphate cells each being charged by the floating charge method two at a time. The three-wire de generator 13 provides 125 volts from either side of the neutral wire to maintain a charging voltage of a little over 3.57 volts per cell.

FI. 3 can have three banks of batteries 10 containing 50 lead acid cells each being charged by the constant potential method of charging two at a time. The three-wire dc generator 13 provides 125 volts from either side of the neutral wire to maintain a charging voltage of 2.5 volts per cell using a small series resistor 15. (This method of charging is not recommended because it provides only about 100 volts to power the prime mover 12.)

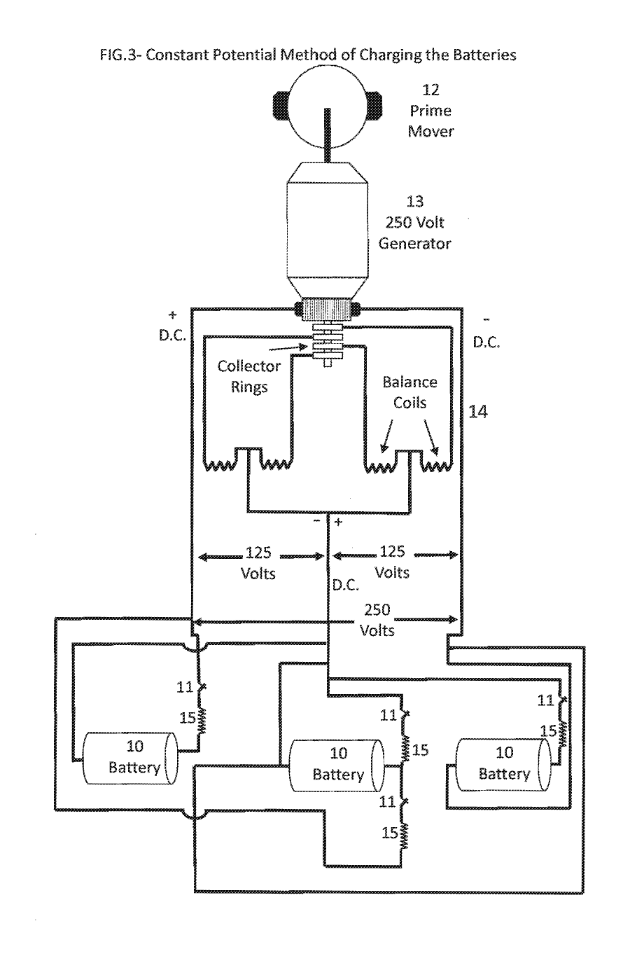

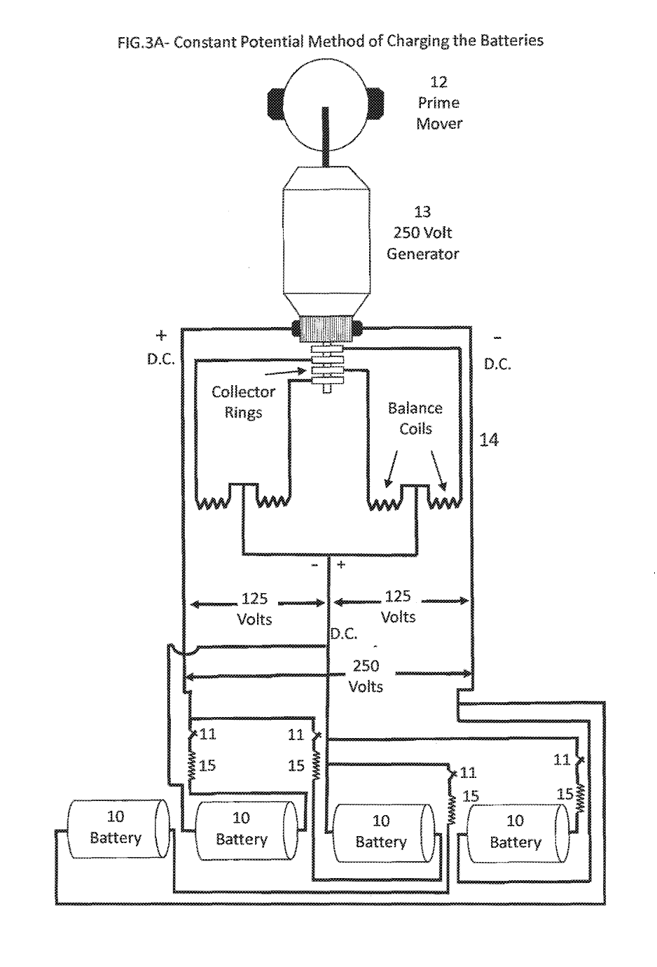

FIG. 3A can have four banks of batteries 10 containing 50 lead acid cell each being charged by the constant potential method of charging two at a time. The three-wire dc generator 13 provides 125 volts from either side of the neutral wire to maintain a charging voltage of approximately 2.5 volts per cell using a small series resistor 15.

FIG. 3 and FIG. 3A can also have three and four banks of batteries 10, respectively, containing 35 lithium-iron phosphate cells each to be charged by the constant potential method two at a time.

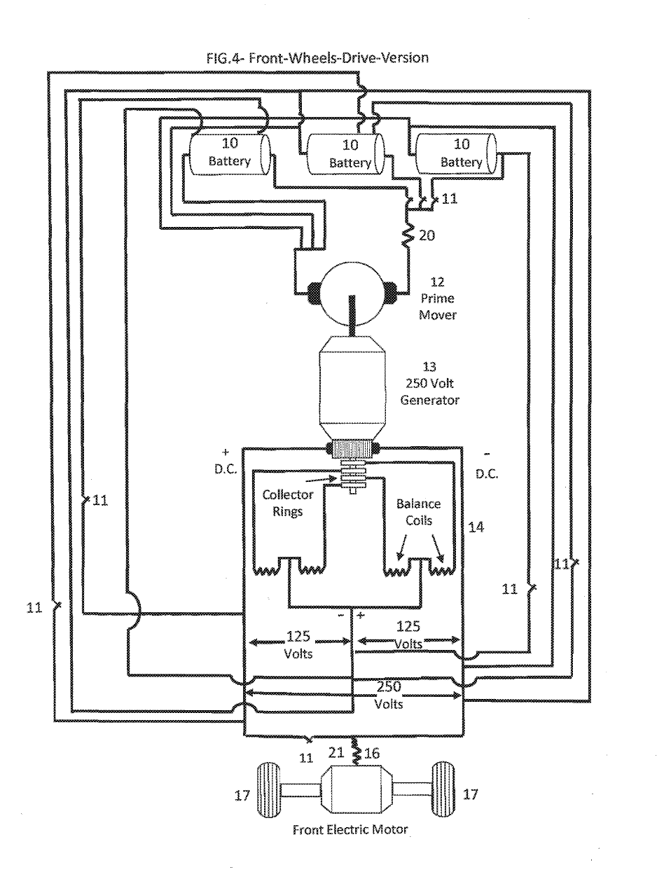

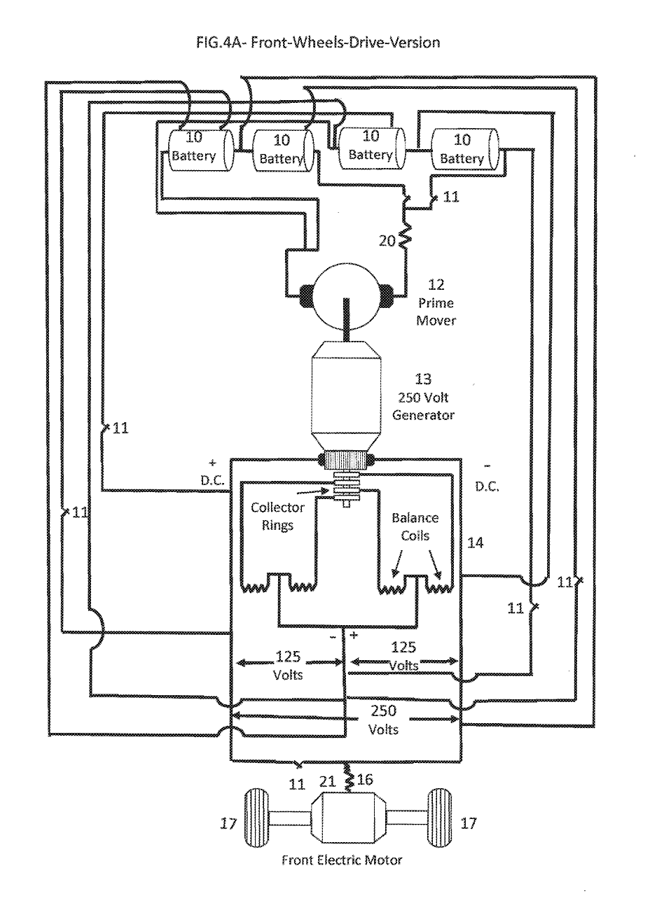

FIG. 4 shows the front-wheels-drive version whereby the vehicle will be self propelled to roll along a surface. While the three banks of batteries 10 containing 58 lead acid cells each provide in rotation, one at a time, power to the prime mover 12, approximately 116 volts, the other two are being charged simultaneously under the fast method of charging. The three-wire dc generator 13 provides an input of 250 volts to the traction motor, a series wound direct current motor.

FIG. 4A shows the front-wheels-drive version whereby the vehicle will be self propelled to roll along a surface. While the four banks of batteries 10 containing 58 lead acid cells each provide in rotation, two at a time connected in series, power to the prime mover 12, approximately up to 232 volts, the other two are being charged simultaneously under the fast method of charging. The three-wire de generator 13 provides 125 volts from either side of the neutral wire to charge two banks of batteries 10 and 250 volts to power the traction motor 16, a series wound dc motor.

FIG. 4 can also have three banks of batteries 10 containing 35 lithium-iron phosphate cells each to provide in rotation, one at a time, power to the prime mover 12, approximately 112 volts. The other two are being charged simultaneously under the fast method of charging. The three-wire dc generator 13 provides an input of 250 volts to the traction motor 16, a series wound de motor.

FIG. 4A can also have four banks of batteries 10 containing 35 lithium-iron phosphate cells each to provide in rotation, two at a time connected in series, power to the prime mover 12, approximately up to 224 volts. The other two are being charged simultaneously under the fast method of charging. The three-wire direct current generator 13 provides 125 volts from either side of the neutral wire to charge two banks of batteries 10 and 250 volts to power the traction motor 16, a series wound dc motor.

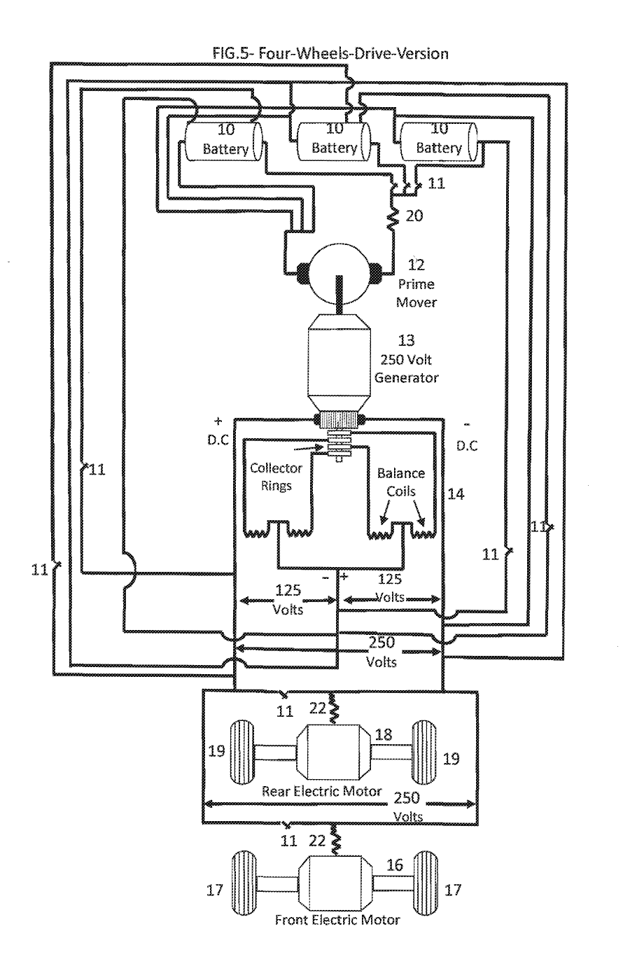

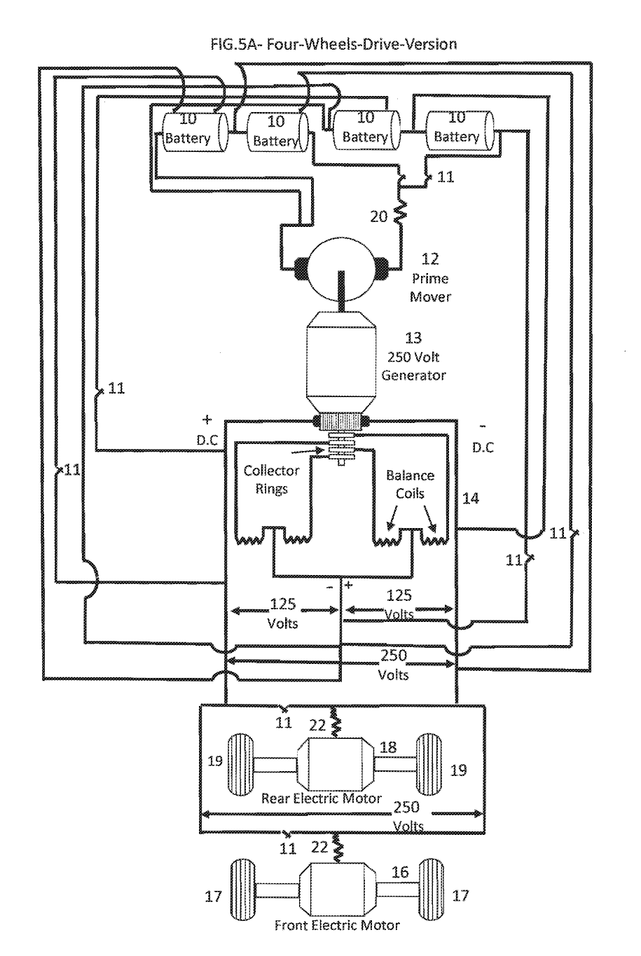

FIG. 5 shows the four-wheels-drive version whereby the vehicle rill be self propelled to roll along a surface. While the three banks of batteries 10 containing 58 lead acid cells each provide in rotation, one at a time, power to the prime mover 12, approximately 116 volts, the other two are being charged simultaneously under the fast method of charging. The three-wire direct current generator 13 provides 125 volts from either side of the neutral wire to charge two banks of batteries 10 and 250 volts to power each of the two traction motors, series wound dc motors.

FIG. 5 can also have three banks of batteries 10 containing 35 lithium-iron phosphate cells each. While the three banks provide, one at a time, power to the prime mover 12, approximately 112 volts, the other two are being charged simultaneously under the fast method of charging. The three-wire de generator 13 provides 125 volts from either side of the neutral wire to charge two banks of batteries 10 and 250 volts to power each of the two traction motors, series wound de motors.

FIG. 5A shows the four-wheels-drive version whereby the vehicle will be self propelled to roll along a surface. While the four banks of batteries 10 containing 58 lead acid cells each provide in rotation, two at a time connected in series, power to the prime mover 12, approximately up to 232 volts, the other two are being charged simultaneously under the fast method of charging. The three-wire dc generator 13 provides 125 volts from either side of the neutral wire to charge two banks of batteries 10 and 250 volts to power each of the two traction motors, series wound dc motors.

FIG. 5A can also have four banks of batteries 10 containing 35 lithium-iron phosphate cells each to provide in rotation, two at a time connected in series, power to the prime mover 12, approximately up to 224 volts. The other two are being charged simultaneously under the fast method of charging. The three-wire direct current generator provides 125 volts from either side of the neutral wire to charge two banks of batteries 10 and 250 volts to power each of the two traction motors, series wound dc motors.

### (4) DETAILED DESCRIPTION OF THE INVENTION

Different types of batteries can be utilized such as: nickel-metal hydride, lithium polymer, lithium-ion, nickel-cadmium alkaline, lithium-iron phosphate, lead-acid, etc. The number of cells will depend on the nominal open circuit voltage per cell. I propose the use of the lead-acid batteries which are the most widely used and the lithium-iron phosphate batteries which are extremely safe and stable to use. Their weight is light and can typically be charged in excess of 2000 times.

Three banks of batteries each comprised of 58 lead-acid cells can be utilized. While the three banks of batteries, in rotation, provide, one at a time, power to the prime mover motor 12, approximately 116 volts, the other two remain always charged by being connected across the three-wire direct current generator which provides 125 volts between the neutral and either side of the line. The generator also delivers 250 volts to power the traction motor or motors. Under the floating charge method the voltage is maintained within the limits of from 2.13 to 2.17 volts per lead-acid cell of the battery with an average as close to 2.15 volts as possible. Sensors, Microcontrollers or Automatic Transfer Switches (ATS) will switch from one bank to another when the charge level reaches an acceptable value of 80% or reaches a specified time limit.

Three banks of lithium-iron phosphate batteries each comprised of 35 cells can also be utilized. The nominal open circuit voltage is 3.2 volts per cell and the charging voltage is approximately 3.6 volts per cell. Two banks at a time will be maintained at full charge by the floating charge method of charging while the third bank provides power to the prime mover 12, approximately 112 volts (3.2 volts/cell×35 cells). The three banks of batteries will rotate to provide, one at a time, power to the prime mover 12 while the other two remain always charged by being connected across the three-wire direct current generator which provides 125 volts between the neutral and either side of the line. Under this floating charge the voltage is maintained a little over 3.57 volts per cell. The generator also delivers 250 volts to the traction motors.

At the start, the generator is brought up to normal speed and, before any load is connected across the armature, the generator must build up its voltage to the rated value. This voltage, 250 volts, will be monitored through a voltmeter mounted in the dashboard and will be kept constant through the speed controller that regulates the speed of the prime mover.

The prime mover 12 is a permanent magnet brushless direct current motor (PMDC) with interior mounted field magnets. In the motor, the field excitation is supplied by permanent magnets. Higher rated power (HP) can be achieved if the PMDC motor is open-vented (OV) or totally enclosed fan cooled (TEFC). The PMDC motor will be designed for an output range of 5-7 HP of more and speeds of 2000 RPM or more. A motor speed controller or rheostat is used to control the speed of the PMDC motor.

Bigger more powerful prime movers can be utilized. The PMDC motor can be designed for an output range of 10 HP or more and speeds of 6000 RPM or more. To power the prime mover four banks of batteries each comprised of 58 lead-acid cells can be utilized. Two banks at a time will be maintained at full charge by the floating charge method of charging. The four banks of batteries, in rotation, provide, two at a time connected in series, up to about 232 volts to power the prime mover motor while the other two remain always charged by being connected across the three-wire direct current generator which provides 125 volts from either side of the neutral wire. Also, to power the prime mover four banks of batteries each comprised of 35 lithium-iron phosphate cells can be utilized. Two banks at a time will be maintained at full charge by the floating charge method. The four banks of batteries, in rotation, provide, two at a time connected in series, up to about 224 volts to power the prime mover motor while the other two remain always charged by being connected across the three-wire direct current generator which provides 125 volts from either side of the neutral wire. From the second bank of batteries only the number of cells required to give the desired voltage above the voltage of the first bank of batteries will be utilized. To keep the banks of batteries, either lead-acid or lithium-iron phosphate always charged the prime mover motor 12 and the three-wire direct current generator 13 can be kept on to provide power even when the vehicle is parked and the traction motor or motors are turned off.

The three-wire direct current generator 13 is an ordinary direct current generator with the modifications and additions described below. It can be designed for 100-250 KW and is usually wound for 125/250 volts, three-wire circuits. Four equidistant taps are made in the armature winding, and each pair of taps diametrically opposite each other is connected through a balance coil. The balance coil may be external or wound within the armature. The middle points of the two balance coils are connected, and this junction constitutes the neutral point to which the third, or neutral, wire of the system is connected. A constant voltage is maintained between the neutral and outside wires which, within narrow limits, is one-half the generator voltage.

The front traction motor suggested is a series wound direct current motor with an input of 250 volts from the de generator and an output of 250 HP (Horse Power) or more and speed of 4500 RPM (revolutions per minute) or more for front wheel-drive models. For four wheel-drive models, the rear traction motor suggested is a series wound direct current motor with an input of 250 volts dc and an output of 250 HP or more and speed of 4500 RPM or more. The direct current series motors are coupled to the load so that a countertorque will always exist and the motors do not run away.

A starting resistance (rheostat) is normally connected in series with the armature circuit of the traction motors to limit the starting current. The armature resistance control is the most common method employed to control the speed of dc series motors. The resistance is gradually reduced as the motors gain speed and eventually it is cutout completely when the motors have attained full speed. The value of the starting resistance is generally such that the starting current is limited to 1.25 to 2 times the full load current. The rheostat can be controlled by a foot pedal which cuts out the resistance step by step as the motors run up. Another method used for the speed control of dc series motors is the series-parallel control. In this system, speed control of two similar de series motors may be obtained by combining series resistance with series and parallel connections of the motors. By this method, two different speeds can be efficiently obtained. The motors are first connected in series through a starting resistor. The resistor is gradually cut out step by step as the motors come up to speed. When all the resistance is cut out each, motor receives one-half the line voltage. This is the first running position. For any given value of armature current each motor will run at half its rated speed. To increase the speed further, the two motors are connected in parallel and, at the same time, the starting resistor is connected in series with the combination. The starting resistor is again cut out step by step until full speed is attained. When the running position is reached, each motor receives full line voltage. The connections are changed automatically as the vehicle accelerates.

The dc motors can be made to run faster than the basic “balancing speed” achieved while in the full parallel configuration without any resistance in the circuit. This is done by “field shunting.” An additional circuit is provided in the motors' field to weaken the current flowing through the field. The weakening is achieved by placing a resistance in parallel with the field. This has the effect of forcing the armature to speed up to restore the balance between its magnetic field and that being produced in the field coils. It makes the vehicle go faster.

For variable speed applications, dc motors can also be controlled by thyristor power converters called DC drives, which provide not only start/stop and motor protection capabilities, but also control aced/decal ramps, speed control and response, reversing, dynamic braking features, etc. An electronic DC drive is a DC/DC converter called a DC chopper. The DC chopper is powered from a DC power source. The electronic control produces a variable DC voltage that when applied to the DC motors' armature varies the armature current, hence, the speed of the motor. The basic DC drive is a variable speed, closed-loop system.

Some direct current three-wire generators are wound for 120/240 volts while others are wound for 115/230 volts. Possibly these three-wire direct current generators can be used to power smaller all electric vehicles.

A battery may be maintained at full charge by connecting it across a charging source that has a voltage maintained within the limits of from 2.13 to 2.17 volts per lead acid cell of the battery. In a Floating Charge the charging rate is determined by the battery voltage rather than by a definite current value. The voltage is maintained between 2.13 and 2.17 volts per cell with an average as close to 2.15 volts as possible. For lithium-iron phosphate cells, under the floating charge, the voltage is maintained a little over 3.57 volts per cell or about 3.6 volts per cell. The floating charge method has been the preferred one throughout this application.

The applied voltage, under the constant potential method of charging, should be about 23 volts for each lead acid cell of the battery when there is no series resistance in the circuit. With 2.3 volts per cell and no series resistance, the current at the beginning of charge is usually too great, so that it is advisable to use a small series resistor. If a series resistor is used, a voltage source of 2.5 or 2.6 volts per cell is desirable, as otherwise adjustments must be made during the charging period.

The banks of batteries can be either air-cooled or liquid-cooled.

The prime mover, the three-wire direct current generator and the traction motors can be water cooled.

All auxiliary functions such as: water pump, air conditioning, lighting and power steering systems are electrically powered.

1. We claim a self-charging all electric vehicle, comprising:
a. three banks of batteries to power in rotation, one at a time, the prime mover, or
b. four banks of batteries to power in rotation, two at a time connected in series, the prime mover,
c. a prime mover which is a permanent magnet brushless direct current motor that drives the three-wire direct current generator,
d. a three-wire direct current generator which provides two 125 voltages from either side of the neutral wire to charge simultaneously two banks of batteries and 250 volts to power the traction motors,
e. front and front and rear traction motors for producing rotational energy, and
f. means for controllably coupling rotational energy from the traction motors to the wheels, whereby the vehicle will be self-propelled to roll along a surface,
g. the floating charge method for charging the banks of batteries two at a time,
h. the constant potential method for charging the banks of batteries two at a time.
